(19) United States
(12) Patent Application Publication
(10) Pub. No.: US 2018/0124878 A1
(43) Pub. Date: May 3, 2018

(54) Rear-view Assembly for a Motor Vehicle with a Heating Device

(71) Applicant: SMR Patents S.à.r.l., Luxembourg (LU)

(72) Inventors: Daniel Fritz, Stuttgart (DE); Douglas Wilson, Fort Gratiot, MI (US); Anthony D'Andrea, Attica, MI (US); Andreas Herrmann, Winnenden-Baach (DE)

(21) Appl. No.: 15/721,918

(22) Filed: Oct. 1, 2017

Related U.S. Application Data
(63) Continuation-in-part of application No. 14/734,562, filed on Jun. 9, 2015.
Application No. 14/734,562 is a continuation of application No. 13/154,961, filed on Jun. 7, 2011, now abandoned.

(30) Foreign Application Priority Data
Jun. 7, 2010 (EP) 10165071.1

(51) Int. Cl. H05B 3/84; H05B 1/02; B60S 1/02; B60R 1/06

(52) U.S. Cl. CPC H05B 3/845; H05B 1/0236; B60S 1/026; H05B 2203/037; H05B 2203/014; H05B 2203/013; H05B 2203/003; B60R 1/0602

(57) ABSTRACT

An exterior rear-view assembly for a vehicle has at least one reflective element and at least one camera fixedly secured to a backing plate and movable therewith. A heating device having at least one heatable element is between the backing plate and the reflective element. The heatable element is divided into first and second regions, wherein the first and second regions are subjected to different heating output over time. At least one information element and at least one window for electromagnetic radiation are disposed in the second region and are visible before the entire reflective element is defrosted.

This is a continuation-in-part of a United States patent application having application Ser. No. 14/734,562, filed Jun. 9, 2015, which itself is a continuation of a United States patent application having application Ser. No. 13/154,961, filed Jun. 7, 2011, and claims priority to European patent application EP10165071.1 which are all hereby incorporated by reference.

### BACKGROUND ART

### 1. Field of the Invention

The invention relates to a rear-view assembly with a heating device, particularly an exterior rear-view assembly for a motor vehicle comprising at least one reflective element and at least one camera, whereby a heating device is applied on a substrate.

### 2. Description of the Related Art

In EP 0 732 865 B 1, a heating device is known, which is formed by carbon fibers, which are conductively connected to each other by a binding agent. A mirror glass is applied on a backing plate for the mirror glass by a bonding layer.

Furthermore, it is known to directly apply a heating installation on the rear side on the mirror glass of a mirror by a screen printing method or similar. As disclosed in FR 2 628 041, however, the reflective layer is then installed on the mirror on the external side, with increased risk of damage to the reflective layer. In addition, in the known process, the conductive paste is cured at a temperature of approximately 670°, which can cause problems in maintaining the bending accuracy in spherical and aspherical mirror pieces.

Alongside, it is also known from DE 10 2004 002 979 A1 to design the rear sided reflective layer on a mirror glass directly as a heating layer.

However, in the process, problems occur in equal distribution of the current flow in the thin reflective layer, as well as maintaining electrical contact with a source of power.

DE 42 23 590 A1 shows a mirror, in which a transparent heating device is attached as an ITO layer on the front side of the mirror glass, which is covered by a protective layer, which is applied by sputtering or by plasma deposition, for example. In this arrangement, the known problems exist in the contacting of thin layers. Additionally, the ITO layer is very sensitive to damages, which can lead to local ‘hot spots.’

Furthermore, FR 2 618 396 A1 describes a backing foil for a mirror glass with a heating device applied by screen printing. On the front side of the heating device turned towards the mirror glass, a secure connection between the mirror glass and backing foil is produced by double-sided tape. In addition, the heating device is sealed through the double-sided tape.

Furthermore, it is known, in general, to produce resistance heating for a mirror glass in the form of a laminated copper foil in a photo etching process, and, subsequently, to attach the copper foil onto the backing plate with double-sided tape.

It is common to the whole prior art that equal heating should be achieved over the whole mirror glass. Hot spots should be avoided in the process, and, of course, current peaks in the heating cables, in order to avoid a burn-out of the heating cables or evaporation of the heating layer.

U.S. Pat. No. 5,610,756 discusses mirror heating for an electrochromatic mirror. In order to optimally operate this mirror, two different modes are provided for the heating installation. A first state quickly heats a core area, in order to defrost the mirror. In the second mode, the whole surface is heated, in order to guarantee an optimal operating temperature for the electrochemical process.

The EP 0 112 930 shows a heatable rear window with a filament, which runs in the form of a logo.

U.S. Pat. No. 4,251,316 shows a heatable exterior mirror, in which a logo is formed in one surface insulated against the heating.

A monitoring device for vehicles, which has a housing and at least one mirror glass arranged in the housing so as to have a front side facing an observer, is known from U.S. Pat. No. 6,703,925. The at least one mirror glass has a reflective layer being reflective in the visible spectral range of light. At least one camera is arranged behind the reflective layer in a viewing direction viewed from the front side. The monitoring device can be used for driver identification, monitoring the driver's condition, identifying passengers and passenger positions, controlling airbags, theft surveillance, and similar purposes.

DE 42 28 794 A1 describes a blind spot monitoring device which uses at least one element for detecting the traffic situation within the vehicle blind spot zone, coupled to an evaluation device for detecting the presence of another vehicle and operating a signaling device for alerting the vehicle driver. The blind spot range is monitored continuously by the element and the evaluation device, the display device only being operated when a vehicle is detected within the blind spot zone. A video camera, temperature responsive sensors, or ultrasonic detectors can be used as the monitoring element.

### SUMMARY OF THE INVENTION

The object of the invention is to provide a rear-view assembly with a heating device, particularly an exterior rear-view assembly for a motor vehicle comprising at least one reflective element and at least one camera, whereby a heating device is applied on a substrate and provides an uneven heating output to facilitates the appearance of an information element on the at least one reflective element and/or the incident of electromagnetic radiation onto the at least one camera during the defrosting or demisting process.

This object is achieved by a rear-view assembly the heating device of which is provided with the features to distribute the surface to be heated in at least two regions, and to load the at least two regions with different heating output or a different temporal heat release.

The production of a heating layer of the heating device can take place with all known procedures.

The invention is explained with the example of a conventional adhesive foil with heating cables.

The known production of resistance heating from a laminated copper foil in a photo etching process resulted in a flexible foil, which is subsequently attached with double-sided tape on the rear side of the mirror. In the process, the heating cables comprise the same distances, thicknesses and widths, so that the applied voltage results in a current flow, which is as equal as possible.

The heating can also be realized by a transparent heating foil such that neither the view of viewers of the at least one reflective element nor the view of the at least one camera is obstructed by the heating.

In addition, an electronic device can be designed as a lighting module, in particular for a perimeter light of the rear-view device.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 shows a heating foil of the prior art;

FIG. 2 shows a top view of heating foil according to the invention;

FIGS. 3 and 3A show second and third embodiments of the invention;

FIG. 4 shows a third coated embodiment;

FIG. 5 shows a perspective view, partially cut away, of the invention incorporated into a mirror assembly of the motor vehicle;

FIG. 6 shows a perspective view, partially cut away, of the invention incorporated into a mirror assembly of a motor vehicle with the mirror glass covered with condensation;

FIG. 7 shows a perspective view, partially cut away of the invention incorporated into a mirror assembly of a motor vehicle with the condensation removed from a second region;

FIG. 8 shows a front view of a mirror glass of the invention, indicating two possible camera positions;

FIGS. 9a and 9b show a front view of a mirror glass and a perspective view of a corresponding backing plate, respectively, of a rear-view mirror assembly of the invention with a camera positioned behind the mirror glass; and

FIGS. 10 to 12 show further embodiments of the invention with alternative heating devices and a camera.

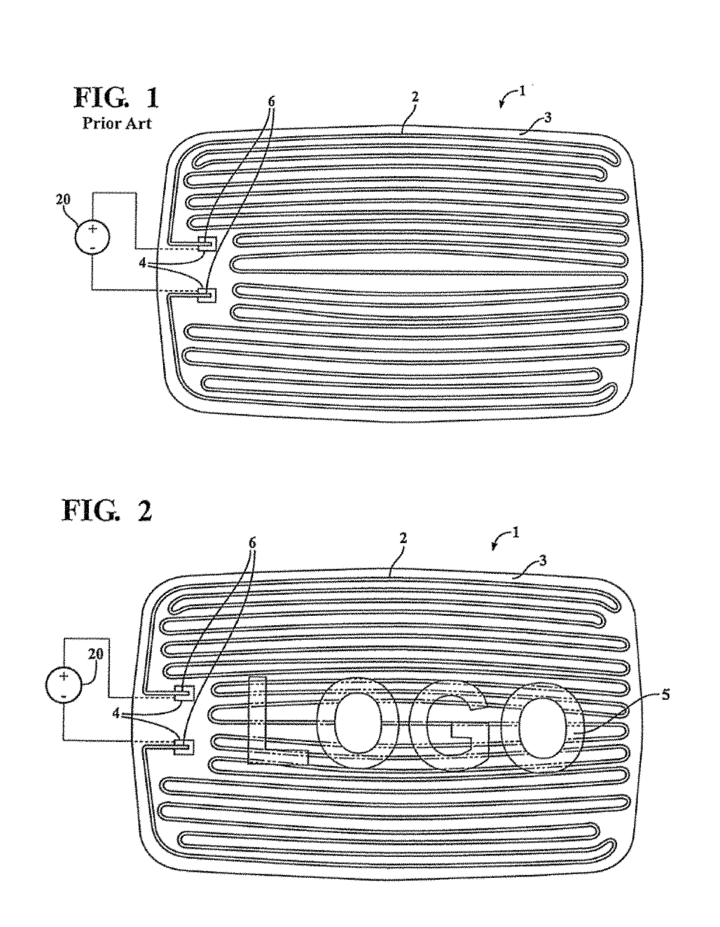

### DETAILED DESCRIPTION OF THE PREFERRED EMBODIMENTS

Modern motor vehicles are fitted with an increasing number of peripheral devices, such as external cameras, sensors, electronic toll payment systems and the like. Many of these devices need to be mounted on the outside of the car and are, for this reason, usually irremovably integrated into outside parts of the vehicle such as rear-view mirrors. This makes it necessary to select the desired devices at the time of purchase of a vehicle. In addition, removal or reconfiguration of such devices is difficult and in many cases not possible at all. Furthermore, the customer is often limited to specific selections and/or combinations of devices as offered by the specific manufacturer.

The term “rear view” is here defined as a view of the surrounding area, which is not in the field of view of a driver, i.e. the directions opposing, left, right, below and above of the viewing direction, but can also comprise the view in the direction of the viewing direction of the driver and/or any combinations of the directions.

The term “driver” and “driver of the vehicle” relates here to the person controlling the main parameters of the vehicle, such as for example direction, speed and/or altitude, e.g. normally the person located in the location specified for the controlling person, for example a seat, but can also relate to any other person or entity within or outside of the vehicle.

Different functions and devices can be incorporated into and/or controlled with the help of rear view devices. Of particular interest are functions and devices to enhance, extend and/or sustain the functionality of the rear-view device during normal or extreme conditions. This can comprise heating and/or cooling means, cleaning means such as wipers, liquid and/or gaseous sprays, actuator means for moving the rear view device or parts of it, such as for example a display, a camera system and/or parts of a camera system, comprising for example lenses, filters, light sources, adaptive optics like deformable mirrors, sensors and/or mirrors, and/or actuator means for inducing movement of other objects, for example parts of the vehicle and/or objects surrounding the vehicle. Furthermore, it can comprise linear tracks and/or rotating wheels, like for example a filter wheel, for exchanging optical elements, comprising for example lenses, mirrors, light sources, sensors, adaptive optics like deformable mirrors and/or filters.

Referring to FIGS. 5 through 7, a backing plate 1 for a mirror 10 shown in more detail, particularly an exterior mirror 10 for a motor vehicle 12, includes a surface 3 turned towards a mirror glass 14, which is visible through a primary opening 16 in a mirror housing 18 and faces rearward with respect to the forward motion of the motor vehicle 12. The mirror housing 18 is movably secured to the motor vehicle 12 via a bracket 19. The surface 3 is part of the heating device and is provided with a meandering conducting path 2. The surface 3 describes a first region of the backing plate without foil, which is heated. The ends 6 of the conducting path 2 are led through on one side of the surface 3, and soldered with angular contacts 4.

The backing plate 1 consists of a plastic material and is stamped from a film, or is produced in an injection molding process, in another design. All types of plastic, which can be manipulated in an injection molding process, are suitable as material for the backing plate 1.

The conducting path 2 is sprayed on meandering in a variety of loops on the front side of the surface 3. The available surface of the backing plate 1 plays a role, inter alia, in selection of resistance materials. In order to achieve a heater current of 2 amps, in vehicle voltage of 12 volts, and thus an electrical output of 24 watts, a cross-sectional surface of the conducting path 2 of 0.2 mm2, and a desired resistance of 6 Ohm, is taken as the starting point.

The heating device (conducting path 2) is powered by a power supply 20 (graphically represented in FIG. 2) that powers the motor vehicle 12 (typically a vehicular battery) and its heating output are measured in such a way that a quick and equal heating of the mirror glass 14 removes condensation 22 either in liquid or solid, e.g. frost or ice, by providing enough thermal energy to the mirror glass 14 to convert the liquid or solid condensation 22 to gas.

As shown in FIGS. 2, 5 and 7 the heating device 2 is modified in such a way that during defrosting of the mirror, an information element in form of letters, a sign or logo appears in a second region 5, to which will be referred to as a logo with respect to the embodiments of FIGS. 2 to 7. The second region 5 includes the surface, which is formed by the letters or signs of a logo. For this purpose, the cross-sectional surfaces of the heating element 2 are reduced by a length; which corresponds to the diameter of the logo. The resistance, and thus the heating current, also increase locally due to the tapering of the cross-section. Through this, a higher heating output is achieved locally in the region of the dimensions of the logo. The mirror to be defrosted is therefore defrosted first of all in the region of the logo, with the structure appearing whilst the rest of the mirror is still iced over or misted. The whole mirror is mist-free within the time desired by the manufacturer.

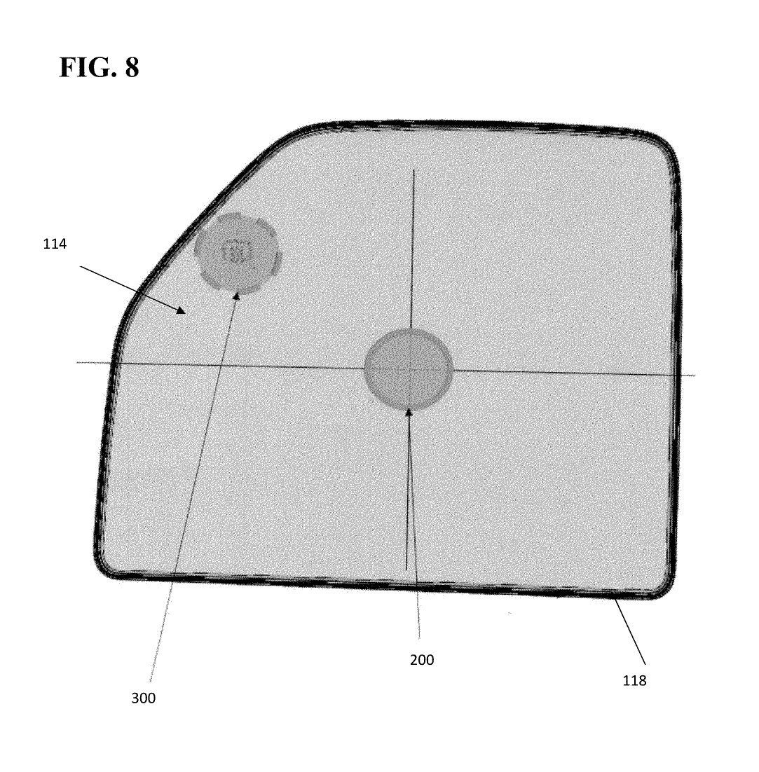

The second region 5 can fulfill many functions, not restricted to allow the presentation of an information element, but also to allow for electromagnetic radiation passing through a window, in particular in form of a light window provided for a cover glass or lens of at least one camera, such that the at least one camera is ready to take images even before the complete mirror is defrosted, deiced, demisted or defogged (hereinafter generally referred to as “defrosted”). This also helps to maintain the camera in an operational state during bad weather conditions, since the heating power delivered to the region of the cover glass or the lens of the at least one camera, the camera viewport, can be higher. This will be further explained with respect to FIGS. 8 to 12 below.

Alternatively, the application can be in inverse form, in which the second region 5 of the logo receives less heating output, and therefore remains as an iced over or misted structure, before it defrosts in the nominal time frame. In one instance, the application of material to create the conducting path 2 may be completely eliminated.

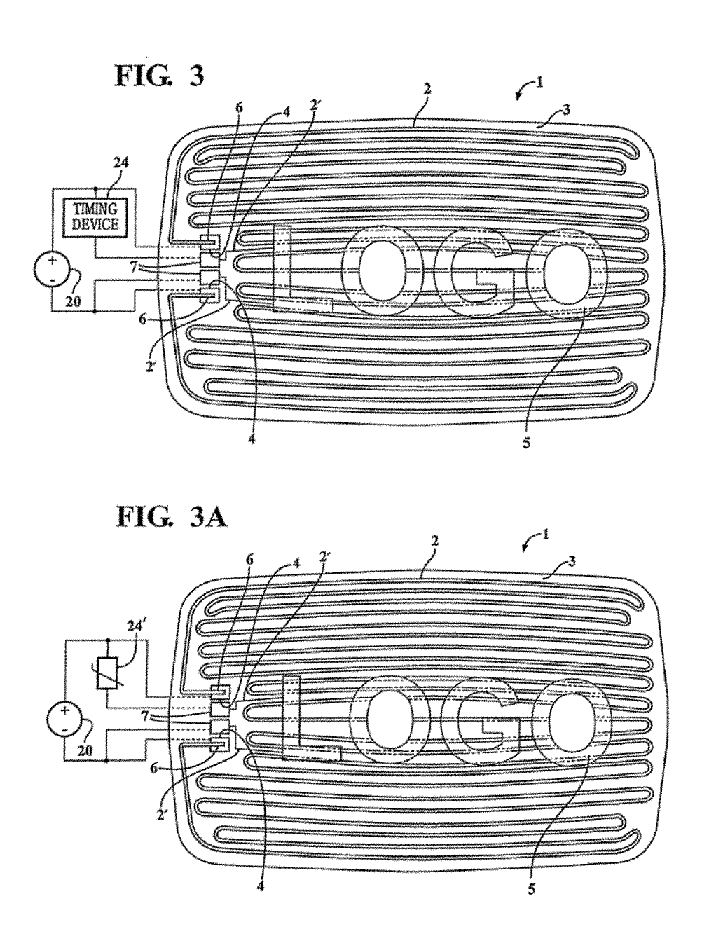

Differing from the execution example shown, two or several separate heating circuits with conducting paths 2, 2′ and contact pairs 4 and 7, electrically separated from each other, can be provided, as shown in FIG. 3. In this embodiment, the targeted conducting paths 2, 2′ separately control the two regions in this heating unit. The layout of two separate heating circuits simplifies the layout of the whole heating element. No transitions need to be provided between different cross-sections of the heating conductor. The risk of burn-out is reduced.

A further embodiment is achieved with the use of two separate heating circuits. The heating wires of a heating circuit are positioned in the process along the contour of a logo. The logo is thus directly defrosted. Above all, this embodiment is suitable for logos which do not have radii which are too narrow, so that the current flow must not be led through these narrow radii in the heating conductor.

A solution is also possible with two separate heating circuits, which control a heating circuit, first of all, and the second heating circuit with a time device, graphically represented by 24 in FIG. 3. The timing device 24 creates a time lag or delay. With this timed solution, total defrosting is achieved in the desired frame, and the layout of the heating circuit is optimized. In one embodiment, the delay device 24 is a switching mechanism with a timing relay.

The timing device 24 may also be a thermistor 24′ (shown in FIG. 3A). If the first section of the mirror glass 14 and thus the thermistor 24′ warms up, it connects the second heating circuit 2′ for this purpose. Therefore, a temperature-controlled, timed solution is given for both heating zones. For this solution, the circuit of the heating installation is to be attached on the surface to be heated, since the surface temperature controls the thermistor 24′.

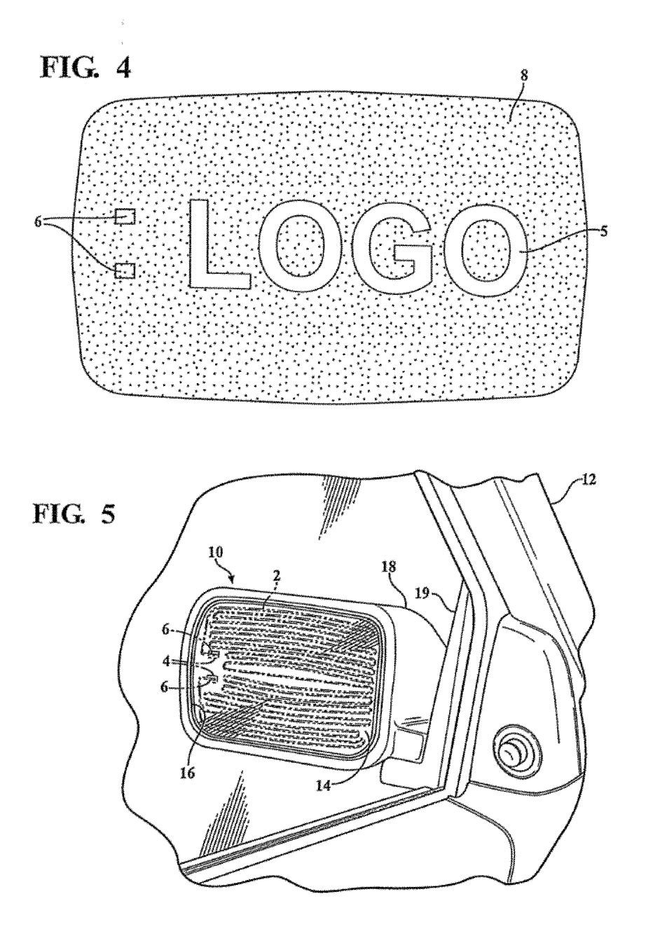

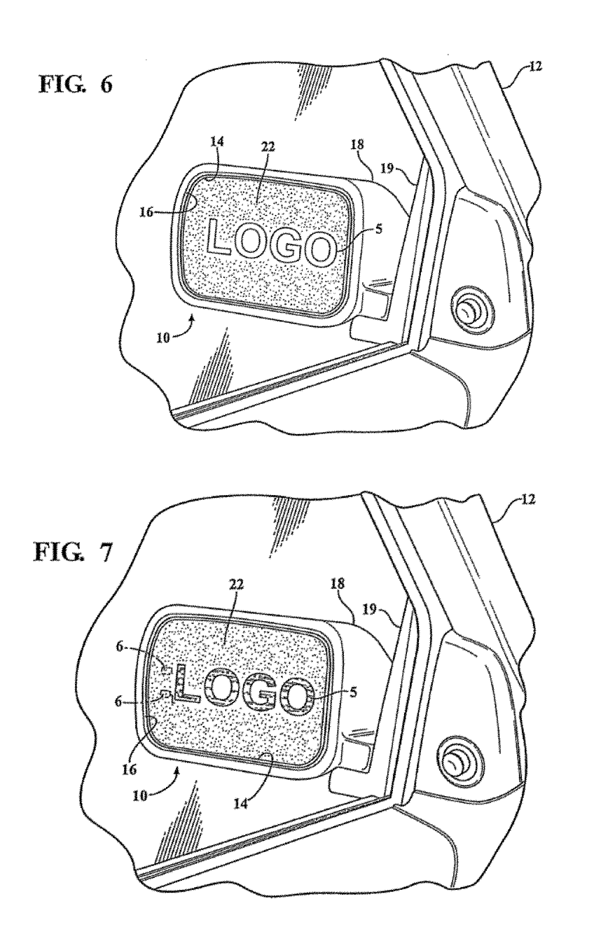

FIGS. 4 and 6 show an embodiment, which works with a flat coating for heating a mirror. The second region 5 of the logo is exempt from the flat coating 8. The rest of the coating must be laid out so that despite the recesses, a homogenous current flow is guaranteed, and the omitted surfaces are equally defrosted by heat conduction within the desired time frame.

FIG. 8 shows a view of a mirror glass 114 of a further embodiment of the invention with two possible locations for a camera system behind the mirror glass 114 exemplarily being depicted, one at a central position behind a first light window 200 and one at an outer position near the housing 118 of the mirror glass 114 behind a second light window 300. The invention provides a high degree of design flexibility by having the first and/or the second light window arranged within the second region 500 to allow for different defrosting scenarios.

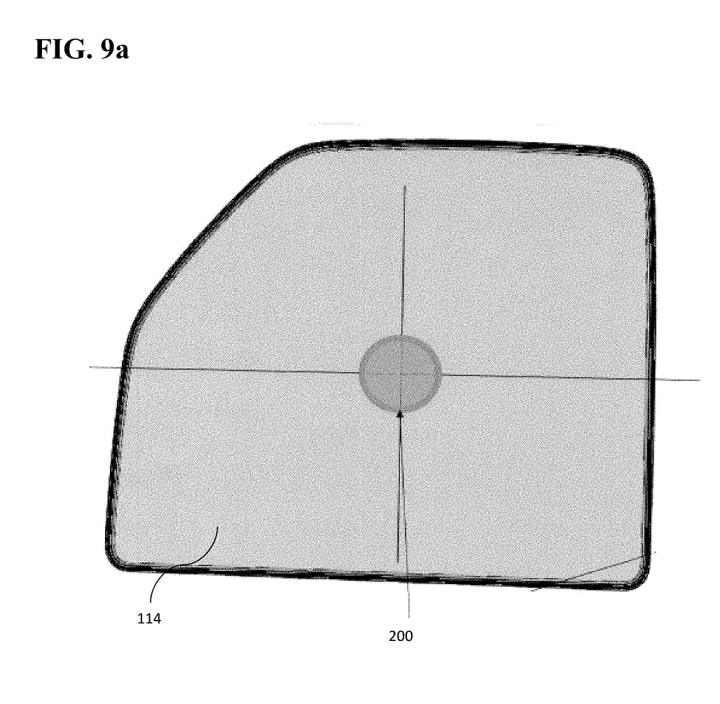

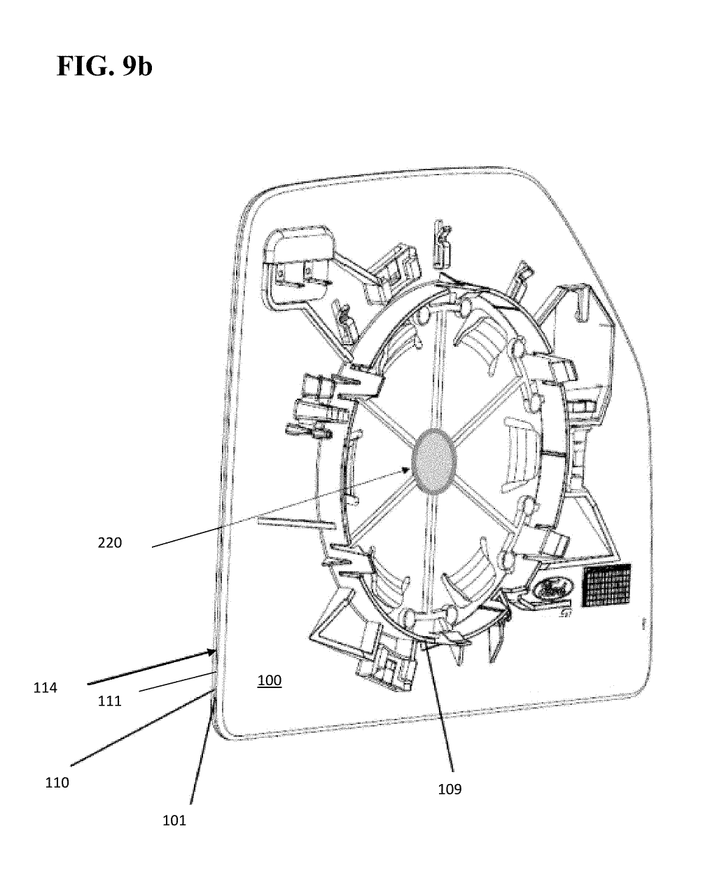

FIGS. 9a and 9b show a further embodiment of the invention, with the mirror glass 114 being provided only with one central light window 200 for a camera 220. The camera 220 with its lens is centrally mounted on the backing plate 100 such that the camera 220 extends into a space between the backing plate 100 and the mirror glass 114 when the exterior rear-view mirror assembly is assembled. The backing plate 100 acts as a substrate for a heating layer 101 onto which a reflective layer 110 and a cover glass 111 of the mirror glass 144 are mounted. In addition, the backing plate 100 is provided with attachment elements 109 on its side opposite the mirror glass 114. The attachment elements 109 serve the attachment to a not shown actuator for moving the backing plate 100 together with the layers 10, 110, 110 thereon as well as the mounted camera 220.

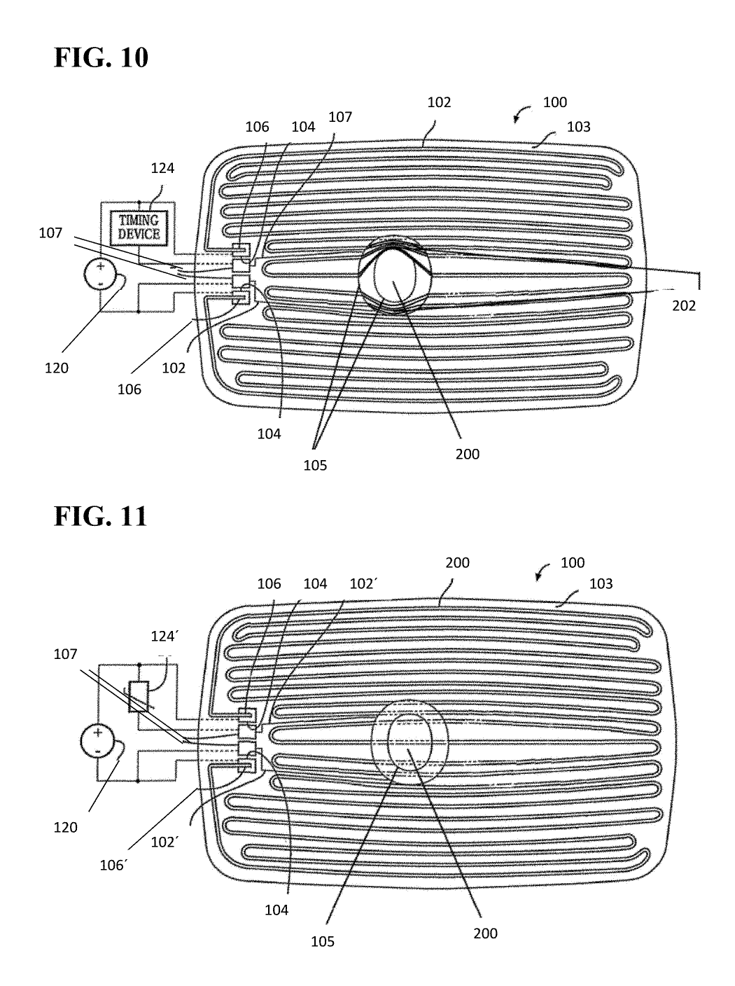

FIG. 10 shows a further embodiment of the invention similar to the embodiment of FIG. 3, but with a light window 200 instead of a logo in the second region 105. From this Figure, an example for the concentration 202 of the conductive paths 102′ around the light window 200 defining a camera viewport can be obtained. The light window 200 lies within the second region 105 in order to deliver additional heating power to the area of and to the surroundings of the camera viewport.

FIG. 11 shows a still further embodiment of the invention similar to the embodiment of FIG. 3A, in which a transparent heating foil is used such that the reception of the electromagnetic waves of the camera is not obstructed by the heating foil. Also here, the light window 200 lies within the second region 105 in order to deliver additional heating power to the area of and to the surroundings of the camera viewport.

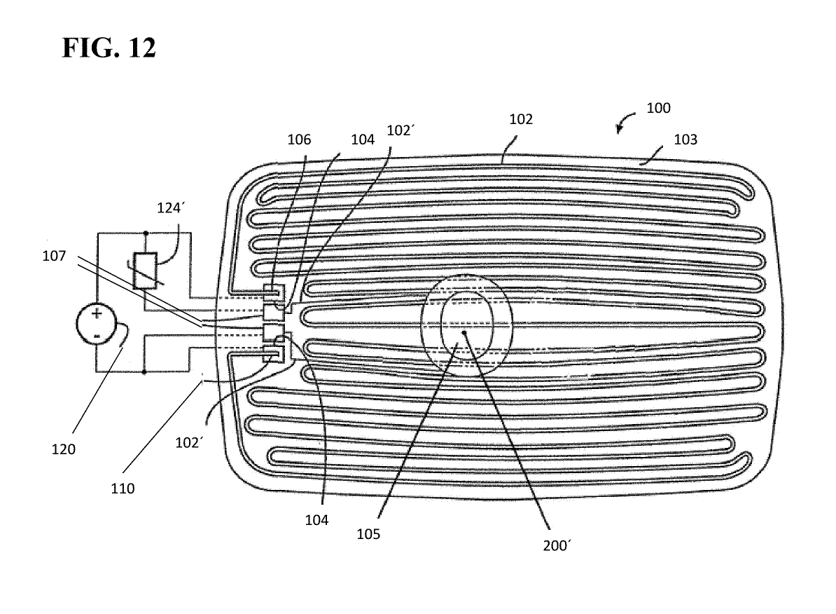

FIG. 12 shows an embodiment of the invention similar to FIG. 11, depicting exemplarily a possible location of an aperture acting as the light window 200 inside the second region 105. The aperture can be provided by the reflective layer of the mirror glass 114.

It lies within the nature of the present disclosure that all of those embodiments illustrated above and in the following, can also be combined.

If a flat coating 8 is chosen, a structuring, e.g. meandering heat conductors, with a laser is possible. The structuring with a laser also facilitates the simplified creation of a logo in the conductive layer. Through the choice of the laser output, together with the writing speed, allows a partial removal of the conductive layer in the region of the logo to be achieved, so that in this region more heating occurs due to the higher resistance.

Alternatively, the application of the heating conductors can take place with different spraying processes.

In an arc spraying process, an arc between two filamentary spraying additions of the same or different compositions is used in order to melt the wire tips. The melted material is sprayed with one or several gas jets, mostly compressed air, and propelled onto the prepared surface of the intermediate layer.

The inert gas arc spraying process can be used to improve the qualities of the coated resistance path. In this process, lower porosity and reduced oxidation is achieved in the layer of the coated resistance material. Entry of air in the hot gas and particle flow is prevented by a second gas flow in a protective body or by a mantle of protective gas around the arc and the spray jet. The speed of the spray jet can also be increased, in order to increase the thickness of the resistance material. Through this, the contact time of the particles of the resistance material with the sprayer and protective gas is reduced.

Ferrous metals, non-ferrous metals, conductive plastics, cermet coatings (sintered ceramic metals) etc, can be used as conductive material. Special alloys with correspondingly selected specific ohmic resistance can also be used.

The application of the conductive material can take place continually along the desired course of the conducting path. In a preferred design of the invention, for speeding up the application of material, a mask is used, which may cover the second region 5, 105, for example, of the surface 3, on which no conductive material should be applied, so that the application of the conductive material can take place in two dimensions.

As well as the application of the conductive material of the conducting path, the periphery of the heating device can be sprayed in a thermal spraying process. Here this can concern the power supply for the conducting path, which is formed by a highly conductive material. Similarly, insulating materials can be applied with a thermal spraying process.

The electrical insulation of the heating device relative to the reflective layer of the mirror glass is done by an adhesive or an insulating varnish. The adhesive or insulating varnish here has a double function, namely, the electrical insulation on one hand, and the connection of the mirror glass with the heating element on the other hand. The reflective layer of the mirror glass, which is sensitive to mechanical strain and environmental influences, is protected by the adhesive or the insulating varnish.

The term “mirror glass” is used in connection with the present invention not only for mineral glass, but also for all possible transparent substrates, for example, of thermoplastic or thermosetting materials.

The solution according to the invention is not limited to representing logos. Any type of note or sign can be shown.

The solution according to the invention is especially suited for the application to defrost a camera viewport, the area which is needed for a camera to receive the incoming electromagnetic radiation.

When producing the mirror typically a reflective layer or coating is applied to the surface of the mirror substrate e.g. in form of a cover glass such that the reflective layer or coating is not facing the environment but rather is protected by the cover glass. When placing a camera behind this cover glass, the camera is equally protected. When placing the camera also behind the reflective layer or coating the amount of light reaching the camera can be reduced.

In one embodiment, this does not pose any problem, since the camera is sensitive enough to use the reduced amount of light reaching the camera for operation.

Alternatively, a light amplifier can be installed between the mirror substrate and the camera, amplifying the amount of light reaching the camera.

In another embodiment, when the reflective coating is reflecting light of a specific wavelength range, for example the visible wavelength range, the camera can nevertheless receive enough light of a different wavelength range or different wavelength ranges, for example the near infrared which can normally not be seen by the driver of a vehicle.

The transparency can of the reflective coating can be controlled. For that purpose, it is especially advantages to make usage of a chromium-based reflective coating as described in US 2017/158138 A1 which is hereby incorporate by reference in its entirety for all purposes.

A further embodiment is characterized by having an aperture or a plurality of holes in the reflective mirror coating, wherein no reflecting coating has been applied or wherein it has been removed. The aperture or holes has or have to be chosen in such a way, that the driver cannot recognize the missing reflective coating and that he is therefore not hampered by it when driving a vehicle. Placing at least one lens behind this aperture or holes allows the camera to collect the light stemming from a large area. In a similar way, the aperture can also comprise an optical fiber to guide the light from the aperture to the camera.

The different embodiments can also be combined to increase the usefulness and the versatility of the present invention.

The camera cover glass or the lens should not be covered with the heating device in order not to distort or cut the images taken by the camera. But in order to be able to defrost the camera viewport, the heating device has to be placed close to camera viewport. Different solutions exist how to preferably defrost the area of the camera viewport.

In one embodiment, the heating is concentrated around the camera viewport in such a way, that the view of the camera is not disturbed but a fast defrosting is ensured, following the disclosure of the present invention and dividing the surface to be heated into at least two regions with different heating rates.

In another embodiment, a heating foil is used which is transparent to the electromagnetic radiation detected by the camera. In this way, the complete surface of the viewport can be covered without disturbing the operation of the camera, ensuring a fast defrosting.

In another embodiment microwaves or other forms of electromagnetic radiation in resonance with the different phases of H₂O are directed at the window or viewport in order to transfer energy to the molecules and enable them to evaporate.

A cleansing system for the whole mirror glass or at least for the window in the viewport of a camera is beneficial. In this respect reference is made to PCT/EP2017/060104 which is hereby incorporate by reference in its entirety for all purposes.

The usage of one or more cameras in addition to a reflective element within an exterior rear-view mirror assembly has a number of advantages:

An interim transitional design step between the currently used rear view mirrors and future camera pods is provided.

Each camera as supplemental field of view device assists in the driver's transition from the current focus on the exterior mirror to a video screen located inside the vehicle.

Cameras can replace currently used auxiliary spotters and even allow for a larger field of view by evaluating image data and/or rotating the mirror glass.

Due to its light weight, cameras are easy to move and allow for a controlled field of view by translatory and/or rotatory movements, for example making usage of a telescoping attachment as described for example in US 2017/080863 A1 which is hereby incorporate by reference in its entirety for all purposes.

### REFERENCE SIGN LIST

1 backing plate
2, 2′ conducting path
3 surface (first region)
4 contact
5 second region
6 end of conducing path
7 contact
8 flat coating
10 exterior mirror
12 vehicle
14 mirror glass
16 opening
18 housing
19 bracket
20 power supply
22 condensation
24 timing device
24′ thermistor
100 backing plate
101 heating layer
102, 102′ conducing path
103 surface (first region)
104 contact
105 second region
106 end of conducing path
107 contact
110 reflective layer
111 cover glass
114 mirror glass
118 housing
120 power supply
124 timing device
124′ thermistor
200, 200′ light window
202 concentration
220 camera
300 light window

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. An exterior rear-view assembly for a motor vehicle having a power supply, said exterior rear-view assembly comprising:
a bracket secured to the motor vehicle;
a housing mounted to said bracket, said housing defining a primary opening facing rearward;
a backing plate movably attached to said mirror housing or moving together with said mirror housing;
a reflective element fixedly secured to said backing plate and movable therewith;
a camera fixedly secured to said backing plate and movable therewith;
a heating device having a heatable element disposed between said backing plate and said reflective element, wherein said heatable element is electrically connected to electrical contacts of the power supply, wherein said heating device is divided into first and second regions, and wherein said first and second regions are subjected to different heating output over time; and
one or more information elements having a diameter, and a window for electromagnetic radiation disposed in said second region.

2. The exterior rear-view assembly according to claim 1, wherein each information element is selected from a group consisting of a letter, a logo, an icon and a sign.

3. The exterior rear-view assembly according to claim 1, wherein each information element becomes visible when said heating device begins to defrost said second region disposed adjacent said heating device.

4. The exterior rear-view assembly according to claim 1, wherein the camera is extending into a space between the backing plate and at least one of a cover of the reflective element, the reflective element and the heating device.

5. The exterior rear-view assembly according to claim 1, wherein the window comprises at least one of a light window, an aperture and a plurality of holes provided by the one reflective element or between neighboring reflective elements.

6. The exterior rear-view assembly according to claim 5, wherein at least one of the light window, the aperture and the plurality of holes is also provided by the heating device or between neighboring heating elements of the heating device.

7. The exterior rear-view assembly according to claim 1, wherein the transparency of the reflective element(s) overlapping the camera is controllable for the electromagnetic radiation heating device.

8. The exterior rear-view assembly according to claim 1, wherein the reflective element comprises a chromium-based reflective coating.

9. The exterior rear-view assembly according to claim 1, wherein the electromagnetic radiation received by the camera increases when said heating device begins to defrost said second region.

10. The exterior rear-view assembly according to claim 1, wherein the heating device has contact with the reflective element.

11. The exterior rear-view assembly according to claim 1, wherein the heating device comprises a foil or film that is transparent to the electromagnetic radiation to be received by the camera.

12. The exterior rear-view assembly according to claim 1, wherein the backing plate provides a substrate on the which the heating device is applied.

13. The exterior rear-view assembly according to claim 1, wherein each of said first and second regions of said heating device includes heating cables with different cross-sections.

14. The exterior rear-view assembly according to claim 13, wherein the cross-sectional surfaces of the heating cables of the second region is reduced by a length, which corresponds to the diameter of the information element or window.

15. The exterior rear-view assembly according to claim 1, wherein each of said first and second regions of said heating device includes heating cables with different resistance.

16. The exterior rear-view assembly according to claim 1, wherein said heating element of said first and second regions is provided with power by a contact pair.

17. The exterior rear-view assembly according to claim 1, wherein said heating device includes one heating element for each of said first and second regions.

18. The exterior rear-view assembly according to claim 1, wherein the one of the first and second regions that is defrosted first includes at least one of said information element(s) and said window.

19. The exterior rear-view assembly according to claim 1, wherein the one of the first and second regions that is defrosted last includes at least one of the information element(s) or the camera.

20. The exterior rear-view assembly as set forth in claim 1, wherein said heating device is flat.

21. The exterior rear-view assembly of claim 1, wherein said heating device includes a pair of heating elements, one for each of said first and second regions, and one of said pair of heating elements is provided with power with a time lag.

22. The exterior rear-view assembly according to claim 21, wherein the time lag is effected by a timing element in the heating device.

23. The exterior rear-view assembly according to claim 21, wherein the time lag is effected by using a thermistor in the heating device.

24. The exterior rear-view assembly according to claim 1, wherein each of said first and second regions of said heating device includes regional coatings with different resistances.

25. The exterior rear-view assembly according to claim 1, wherein each of said first and second regions of said heating device includes regional coatings with differing material compositions and differing thicknesses to create different resistances.

26. The exterior rear-view assembly according to claim 25, wherein said coatings is applied by an arc spraying process, with an arc between two filamentary spraying additions of the same or different compositions being used in order to melt wire tips, the melted material being sprayed with one or several gas jets, mostly compressed air, and propelled onto the prepared surface of an intermediate layer and the speed of the spray jet being increased to increase the thickness of the resistance material in the second region.

27. The exterior rear-view assembly according to claim 1, wherein a light amplifier is arranged in front of the camera.
